(19) United States
(12) Patent Application Publication
(10) Pub. No.: US 2022/0043965 A1
(43) Pub. Date: Feb. 10, 2022

(54) Collaborative Handbook System

(71) Applicant: Epic Systems Corporation, Verona, WI (US)

(72) Inventors: Carl Dvorak, Verona, WI (US); Alan Hutchison, Madison, WI (US); Mike Lonergan, Mount Horeb, WI (US); Janet L. Campbell, Madison, WI (US); Anna Green, Madison, WI (US); John Hansen, Madison, WI (US); Kyle Bernard, Neenah, WI (US)

(21) Appl. No.: 17/387,271

(22) Filed: Jul. 28, 2021

Related U.S. Application Data
(63) Continuation of application No. 13/559,419, filed on Jul. 26, 2012, now abandoned.
(60) Provisional application No. 61/511,831, filed on Jul. 26, 2011.

(51) Int. Cl. G06F 40/166; G06F 40/103; G06F 40/197

(52) U.S. Cl. CPC G06F 40/166; G06Q 10/101; G06F 40/197; G06F 40/103

(57) ABSTRACT

A computer-implemented electronic commons system for sharing information. The system including an electronic content management computer executing a stored program to implement the steps of (a) receiving electronic information content from users, the electronic information including identification of at least one author, (b) receiving instructions from users to organize multiple electronic information content into a handbook, (c) generating a handbook including the multiple electronic information content stored on a computer readable medium of the electronic content management computer based on the received instructions, (d) generating an attribution for the handbook, the attribution including the identifications of the authors of the constituent electronic information content in the handbook; and (e) displaying a representation of the attribution of the handbook.

### CROSS REFERENCE TO RELATED APPLICATION

This application is a continuation and claims the benefit of U.S. Non-provisional application Ser. No. 13/559,419 filed Jul. 26, 2012, and Provisional Application No. 61/511,831 filed Jul. 26, 2011, the entire contents of which are hereby expressed incorporated by reference into the present application.

### BACKGROUND OF THE INVENTION

The present invention relates generally to computerized systems for sharing information among individuals and in particular to a computerized system that allows groups of individuals to collectively assemble organizationally-complex documents such as handbooks.

The ability of large groups of loosely allied individuals to create substantial bodies of shared information is demonstrated in wiki projects such as Wikipedia, a crowd-sourced encyclopedia currently holding over 18 million articles. Such enterprises allow users to upload content and search for that content. Users may also edit content and are given attribution for uploaded content and editing of content in a history page.

In addition to allowing for information retrieval-type searches, enterprises such as Wikipedia provide a conventional organizational framework of an encyclopedia with articles having references and cross-references. Article categories may be merged or separated based on input from the users. The users may also communicate through discussion pages.

### SUMMARY OF THE INVENTION

The present invention allows groups of individuals to generate organizationally-complex documents such as handbooks or textbooks where both content and organization require substantial effort. Encouragement of both content generation and organization is promoted through a closed community attribution system that preserves source information when materials are combined and organized and that provide certifiable credentials to contributors. Multiple competing content and organizations of content may exist and evolve. Crowd-sourced tagging of content and voting on content and vetting of content authors (for example, with user-awarded “badges”) assist in indexing and classifying information for retrieval.

One embodiment of the invention relates to a computer-implemented electronic commons system for sharing information. The system including an electronic content management computer executing a stored program to implement the steps of (a) receiving electronic information content from users, the electronic information including identification of at least one author, (b) receiving instructions from users to organize multiple electronic information content into a handbook, (c) generating a handbook including the multiple electronic information content stored on a computer readable medium of the electronic content management computer based on the received instructions, (d) generating an attribution for the handbook, the attribution including the identifications of the authors of the constituent electronic information content in the handbook; and (e) displaying a representation of the attribution of the handbook.

According to one aspect of the invention, the steps also include receiving an organization structure for the handbook wherein organizing multiple electronic information content includes assigning each piece of electronic information content to a place in the organization structure, where the electronic information content includes handbooks and associated organization structure and author identification.

Another aspect includes where author identification for an electronic information content is automatically assigned to any handbook including that electronic information content and/or the organization structure of an included handbook is preserved within an including handbook. This aspect may further include receiving a request to apply the organization content of an included handbook in the including handbook.

In another aspect of the invention, the steps also include receiving electronic information content from users further includes requesting and receiving authentication credentials of the author prior to allowing inclusion into the handbook.

Another exemplary embodiment of the invention includes a computer-implemented method of generating user handbooks embodied in a computer readable medium of a first computer system. The method includes searching for a current user handbook comprised of an electronically accessible collection of information documents having a organization structure, in an electronically accessible handbook repository, importing a current user handbook into a handbooks space associated with an identified individual on the first computer system, receiving instruction at the first computer system to modify the current user handbook in the handbooks space, the modification including changing at least one of an organization and an information document, and publishing the modified current user handbook into the electronically accessible handbook repository.

Another exemplary embodiment includes an electronic community computer system for sharing information implemented on at least one electronic computer. The system executes a stored program to register individual users with tags indicating interest, receive electronic documents from individuals for storage in a computer readable medium of the electronic community computer system, receive an electronic search request identifying at least one electronic document, display the identified at least one electronic document, receive at least one expertise points award designation for the identified at least one electronic document, determine whether cumulative expertise points award designation for at least one electronic document are greater than a threshold for at least one individual user having a tag indicating interest in that type of electronic document, and transmit the electronic document to the at least one individual user based on the determination.

### BRIEF DESCRIPTION OF THE DRAWINGS

FIG. 1 is a simplified representation of a set of networked workstations communicating with the central data server suitable for implementation of the present invention;

FIG. 2 is a simplified representation of a data structure held by the server of FIG. 1 showing data spaces identified to individuals, the data spaces holding documents, handbooks, and scrapbooks each linked to tags and attributions for the collaborative handbook generation activity;

FIG. 3 is an attribution graph showing a tracking of the elements of the handbook for attribution and/or “badging” of documents and users by other users;

FIG. 4 is a user's page showing a user's handbook and biographic information about the user together with mechanisms for tagging documents in handbooks, badging documents and users and providing authenticated certificates reflecting user contributions; and

FIG. 5 is an activity diagram showing activities implemented by the present invention for content generation organization and retrieval.

### DETAILED DESCRIPTION OF THE PREFERRED EMBODIMENT

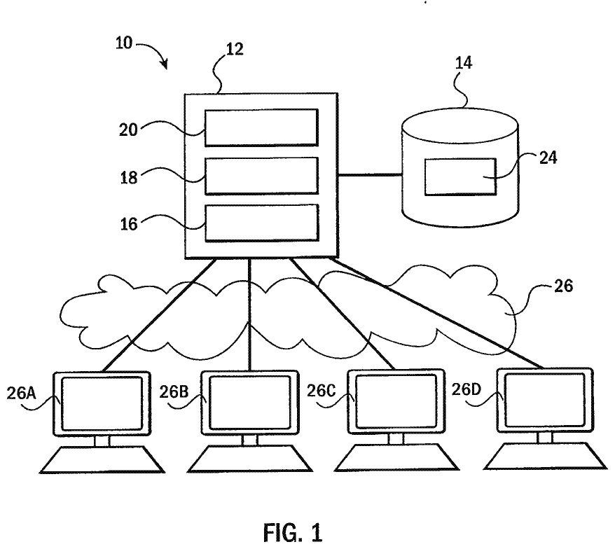

Referring now to FIG. 1, the present invention may employ a server system 10 having a central server 12 (possibly implemented by a number of interconnected machines) communicating with a database 14. The server system 10 may generally include a web interface 16, and operating system 18, and an application program 20, as will be described below. The database 14 may hold a data structure 24 having data spaces 28 assigned to individual users as will be described below. The central server 12 may communicate via the web interface 16 with multiple user terminals 26a-26d exchanging data with server system 10 over a network, for example, the Internet 26.

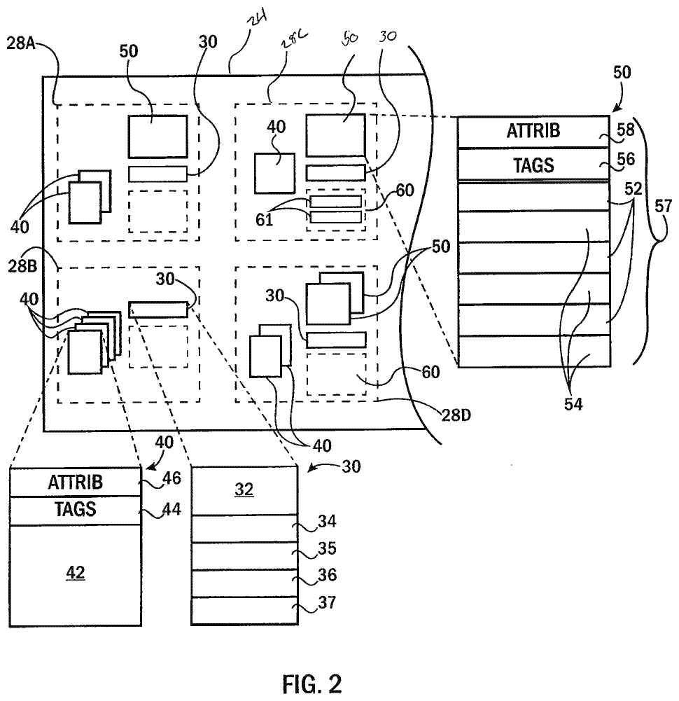

Referring now to FIG. 2, the data structure 24 may include a set of logical data spaces 28a-28d (only four shown for clarity) each assigned to an individual who may use the server system 10, the individuals being either a natural person or an entity such as a healthcare delivery organization or company. Generally persons, institutions and companies will have separate data structures 28 and each will be identifiable by others without anonymity. Each data space 28 includes biographical data 30 including user identification information 32 such as verified information identifying the individual including, for example, the individual's legal name, affiliated organization, e-mail, phone number, etc. This information may be verified by conventional verification techniques of seeking corroboration of identity and references by other known individuals. The biographical data 30 may also include information about the individual's interests 34, areas of expertise 35, and credentials including badges 36 and citation statistics 37 as will be described below. Interests may be confined to specific topics (enforced by a menu structure or other means) related to a common endeavor of the users (e.g., the topics of handbooks) and may be controlled by either the individual or a supervisor of the individual or other administrator or may be originated by the users and solely under user control.

Each data space 28 may also include one or more documents 40 prepared or authored by the individual. Such documents may be text, images, video, or the like which provides content 42. The documents 40 are also linked to tags 44 being, in a preferred embodiment, text words or phrases related to the content 42. The documents 40 are also linked to attributions 46 indicating authorship or editorship with respect to the content 42. Generally these documents 40 are shared, meaning they can be viewed and searched by other individuals. However, as the documents reside within the data space 28 of the individual, editing rights may be optionally reserved to the individual authoring the document 40. Such a reservation does not prevent editing copies of the documents in other data spaces 28, however, by other individuals.

Data spaces 28 may also include one or more handbooks 50. Generally handbooks 50 are data files constructed by users and composed of structured lists of pointers 52 to documents 40 and interstitial content 54 (for example explanatory text, titles, and headings) describing or linking the content of the pointers 52 into an organized whole. An organizational structure 57 of the pointers and interstitial content 54 (including formatting, visual layout, ordering, stacking and section divisions) is preserved and recorded in the handbooks 50, for example, as a graph or other commonly understood data structure.

Handbooks 50 also include tags 56 and attributions 58, the former related to the collective content of the handbook 50 and the latter related to the content and/or the editorship creating the organizational structure 57. The interstitial content 54 may receive attribution separately from the attribution of the editorship if desired. Generally these handbooks 50 are also shared, meaning they can be viewed and searched by other individuals. When handbooks 50 are based on handbooks 50 developed by others, possibly including editing by users other than the original author as well as the user of the given dataspace 28, the user's dataspace 28 may hold a user's copy (reproducing the data of the original source handbook 50 while preserving the pointer for attribution), the copy being available for editing, saving and deleting by the user of the given dataspace 28. Alternatively, the user's dataspace 28 may hold only the edits by that user with the underlying document being provided by a pointer or set of pointers each possibly associated with edits stored in other user's dataspaces 28. The end effect is that the user may effectively copy other handbooks 50 and edit them freely while attribution is preserved.

The data spaces 28 may also include a scrapbook 60 that may hold pointers 61 to documents 40 and draft interstitial content 54 and the like to be used in the generation of a handbook but which is not public or shared at that time and is used primarily for collecting information by the user.

The data of this data structure 24 may be stored and indexed as will he described below in a database structure for rapid searching. Generally, the handbooks 50 and the scrapbooks 60 may be viewed by the user in which case the pointers 52 are manifested as icons or small images of the material to which they point.

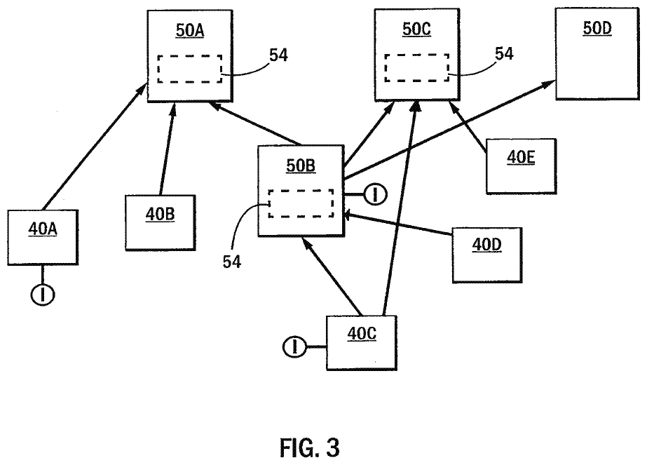

Referring now to FIG. 3, generally a handbook 50a may include some interstitial content 54 original to the handbook but more typically will be constructed of various documents 40a and 40b prepared by other individuals and possibly other handbooks 50b also prepared by another individual. Constituent handbook 50b may in turn be generated from documents 40c and 40d generated by different individuals. Documents 40 may include multiple media types such as photographs, videos, PowerPoint slides, text or word processor files, hypertext documents, xis documents, and the like.

A given constituent document 40c and constituent handbook 50b may likewise be part of another handbook 50c which in turn may also incorporate a document. 40e. This process may share either or both of content and organizational structure as illustrated, for example, by handbook 50d which may have simply adopted the content of handbook 50b with reorganization and only minor additional interstitial content 54.

The present invention tracks the attribution of each element in this sharing process to provide for an attribution inheritance. Thus, for example, if documents 40a and 40c and handbook 50b are authored by author [1] (this information contained in the attribute 46 of that document 40 and attributions 58 of handbook 50), these attributions are inherited by handbook 50a. The attribution and inherited attributions may be viewed by a viewer of the handbook 50a either in a separate attribution window (as will be described) or in the form of footnotes or the like thus giving all authors credit for their contribution of content and organization and promoting the generation of high quality content.

In addition, the inheritance of attributions may be used to develop statistics that indicate the popularity of a particular author's works. These statistics will be visible on the author's site as will be discussed below. Thus, for example, in the inheritance pattern of FIG. 3, author [1] would have credit for authoring two documents (40a and 40c) and for authoring one handbook 50b. Further, author [1] would have credit for four content incorporations (handbooks 50a, 50b, 50c, and 50d) and three organizational incorporations (handbooks 50a, 50c, and 50d). This use of the material of author [1] provides credentials to the author based on use by other members of the user community or elsewhere and which may be quantified and used in a search filter for finding particular content or organization structure. In addition, 40c is a more “valuable” document (since it is referenced in two direct handbooks and in two handbooks that contain those handbooks). Document 40c, by its inclusion in handbooks, is inferably more useful than 40a.

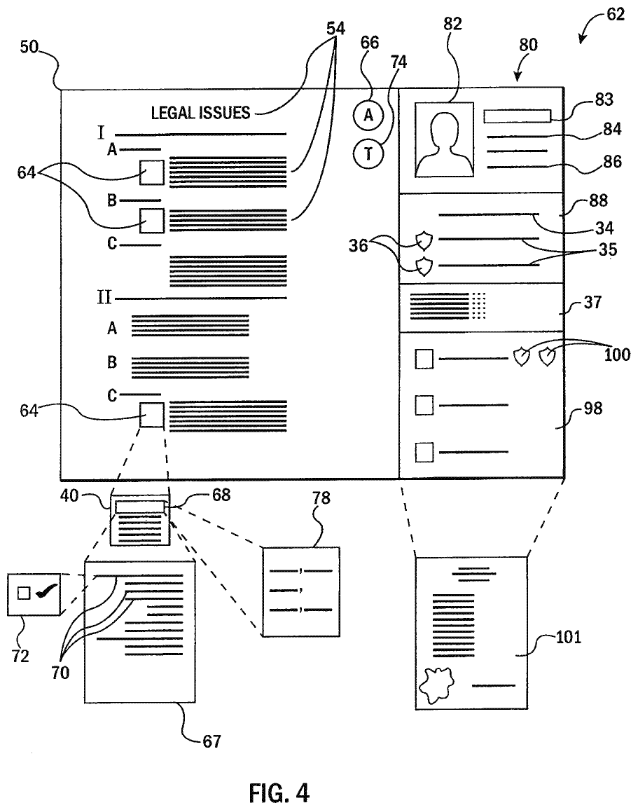

Referring now to FIG. 4, the data of data space 28 may be visible in one or more pages generated in response to a search query or may be viewed at a home space page 62 linked to a particular user. In this latter case, an example home space page 62 may provide a display window, for example displaying handbook 50 of the user to be edited by that user. The handbook 50 as displayed exhibits organizational structure (here represented by an outline form) made up of interstitial content 54 spatially organized together with icons 64 representing pointers to other content. Optionally, the content represented by the icon 64 may he displayed in full. This view is similar to that provided to another user reviewing the handbook 50.

In both cases, an attribution icon 66, may provide, for example, a method of determining the attribution to the entire document (by hovering over document whitespace) or portion of the document (by hovering over an icon 64) to invoke an attribution screen 67. Alternatively “clicking” on an icon 64 associated with a handbook 50 may open the document 40 exposing an attribution portion 68 (e.g. author block) which may be expanded into attribution screen 67. The attribution screen 67 provides those authors contributing to the document 40 or handbook 50 ranked, for example, according to a percent word count contribution or other ranking methodology.

A given entity 70 in the attribution screen 67 may be selected to activate a voting window 72 allowing a user viewing the voting window 72 to indicate how valuable they found the particular information associated with the attribution screen 67. These votes contribute to “badges” that can be awarded to the particular authors, documents or handbooks. In the case of the collected work such as a handbook 50, the badges may be allocated in different predetermined percentages to both the editor defining the organization of the information and to the authors contributing content. Alternatively, or in addition, separate voting may be provided for organization of the document versus content. In this way, content providers and information organizers are given credit for and thus incentive to produce high quality work. It should be noted in this regard that each user of the system is authenticated and hence the opportunity for multiple identical voting (ballot box stuffing) by an individual for a given element of content or organization may be precluded by a simple tracking mechanism. The person casting a vote may nevertheless remain anonymous to the person receiving the vote.

Referring still to FIG. 4, an icon 74 similar to icon 66 may be provided for viewing and adjusting the tags associated with each document 40 and handbook 50 and used for searching the individual content or organizational elements. Moving the icon 74 over a particular element of the handbook 50 may invoke a tag screen 78 which may also be invoked directly from the document 40. The tag screen 78 lists the current tags for the particular element, for example, document 40. The user may use this tag screen 78 to add to the tags or delete tags, allowing the community to improve the indexing of the information. The additions or deletions may operate directly on the tags 56 or tags 44 associated with the document 40 or handbook 50 or may contribute only cumulatively to the tags and a weighting associated with individual tags and used as a weighting in a conventional information retrieval type search. Alternatively or in addition, users may rank the tags in order according to how important they believe the tags to be in describing the work, and the ultimate tags may be given a weighting that is a composite of user rankings or alternatively the tags and/or the weighting reflect the ranking of the latest user.

Contemporaneously, with the display of a user's handbook 50 or other documents a user biographical section 80 may also be shown, here shown as a sidebar. The biographical section 80, for example, could include a picture 82 of the user together with the user's actual name 83, institutional affiliation 84, and address 86, for example, an e-mail address. This information may be obtained from the biographical data 30 of the data structure.

A qualification section 88 may list the user's self identified interests 34 and self identified and crowd identified expertise 35 which may be associated with one or more badges 36, for example, presenting different colors or numbers of badges indicating the results of the voting of individuals using voting window 72. A bibliography section 98 lists the users documents 40 and handbooks 50 which may be displayed in the left side of the screen, for example, as shown with respect to the handbook 50 previously described. Each of these elements of content may also be given badges 100 by voting system similar to that provided at voting window 72. The badge information may be stored to permit a search filter to be limited to material having a certain number or more of badges.

A section 37 may be also provided to indicate the statistics discussed above with respect to citation of the users works. These statistics are also stored and may be used in searching for content or organizational structure.

In this regard, it is contemplated that the user may generate a certificate page 101 incorporating all the data of the biographical section 80 that may be viewed by persons inside and outside of the community of users of the server system 10 providing authors of content or editors of organizational structure recognition for their work and skill. In one embodiment such a certificate may be prepared by a sponsoring organization as an official document and provided to the user on letterhead or otherwise marked paper for their use. Again, the provision of quality content and effort is rewarded by this recognition.

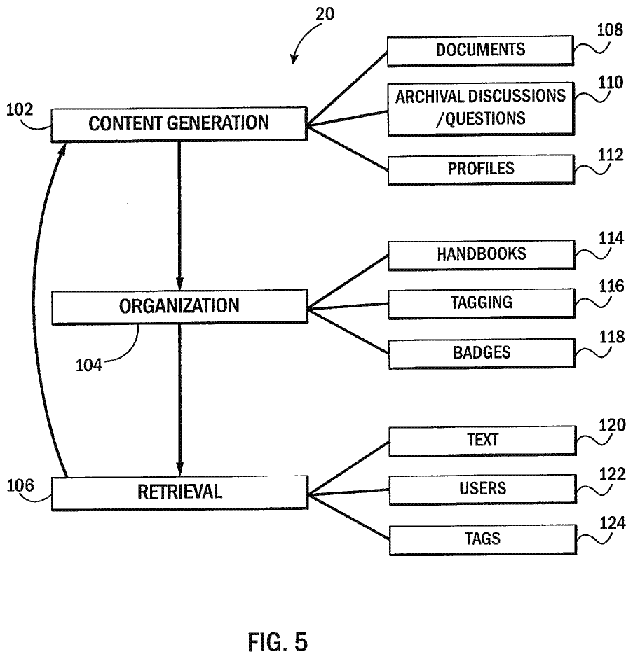

Referring now to FIG. 5, it is contemplated that the present invention will exist within a framework incorporating other software elements providing features of a comprehensive social networking system. Generally, the invention may optionally provide for server-side programming, or the like, allowing for content generation, indicated by process block 102, content organization, indicated by process block 104, and content retrieval, indicated by process block 106.

In this first context, invention may allow users to generate, upload, or edit documents as indicated by process block 108 using an editor program or the like. Documents in this context would include not only text but also images, sound, video and the like. It is also contemplated that content may be generated in the submission of questions and answers through an archival forum allowing users to participate in conversations with other users and ask questions that are saved and searchable or that may be included in whole or in part in handbooks 50, a feature indicated by process block 110. In addition, users may generate, upload, or link to profile information indicated by process block 112 for their biographical data 30. Each of these elements provides value to the user community.

The organization of data indicated by process block 104 is primarily the activity of generating handbooks 50 by collecting content and organizing it with interstitial content 54 indicated by process block 114, and also the tagging of documents 40 and handbooks 50 indicated by process block 116 and the voting on badges indicated by process block 118.

Information retrieval indicated by process block 120 will occur using standard database queries and/or information retrieval searches that will allow database and/or text searching of the text of documents 40 or for text incorporated into handbooks 50 either directly or by reference. In addition, searching by authors either directly or as a search filter, as indicated by process block 122, may be done. This searching may allow user qualifications to be designated in conjunction with or in lieu of the username. In addition, tag searching may be done as indicated by process block 124 allowing documents 40 or handbooks 50 to be identified by their tags. A tag synonym table may be provided to expand tag searching or a menu of particular tags available in dictionary form may be provided to assist the user in this regard. The user may selectively limit the search to be only of documents 40 or handbooks 50.

It is contemplated that the system of the present invention will be closed in the sense that all users will be registered and monitored so that a sponsoring organization or the like may moderate the information uploaded edited and disseminated.

It is expected that an e-mail system would also be incorporated into the design allowing users to forward content, for example, for review to other users. Users may also be certified by an independent authority with respect to levels of expertise which may provide yet another dimension by which searches may be qualified (for example, requesting retrieval only of material from designated experts). Likewise voting by designated experts may be given greater weight or weighted separately, the experts being designated by the badging system described above or by a third party administering the system or by an algorithm monitoring activities performed by the individual, such as word counts of documents authored by the individual or participation by the individual in discussions or user's group meetings, or other objective measures. In addition, the e-mail system could provide for publication or pushing content to users according to subscriptions or particular interest tags 90.

It will be appreciated that the logical structures described above need not limit the actual implementation of the data structures which may be stored and organized differently for retrieval or updating efficiency.

We claim:

1. A computer-implemented electronic commons system for sharing information comprising an electronic content management computer executing a stored program to implement the steps of:
(a) receiving electronic information content from users, the electronic information including identification of at least one author;
(b) receiving instructions from users to organize multiple electronic information content into a handbook;
(c) generating a handbook including the multiple electronic information content stored on a computer readable medium of the electronic content management computer based on the received instructions;
(d) generating an attribution for the handbook, the attribution including the identifications of the authors of the constituent electronic information content in the handbook; and
(e) displaying a representation of the attribution of the handbook.

2. The system of claim 1, further including receiving an organization structure for the handbook wherein organizing multiple electronic information content includes assigning each piece of electronic information content to a place in the organization structure.

3. The system of claim 2, where the electronic information content includes handbooks and associated organization structure and author identification.

4. The system of claim 3, wherein the author identification for an electronic information content is automatically assigned to any handbook including that electronic information content.

5. The system of claim 3, wherein the organization structure of an included handbook is preserved within an including handbook.

6. The system of claim 1, wherein receiving electronic information content from users further includes requesting and receiving authentication credentials of the author prior to allowing inclusion into the handbook.

7. The system of claim 5, further including receiving a request to apply the organization content of an included handbook in the including handbook.

8. The system of claim 4, wherein the author identification for an electronic information content includes the identification of the author's healthcare delivery organization.

9. A computer-implemented method of generating user handbooks embodied in a computer readable medium of a first computer system, the method comprising the steps of
(a) searching for a current user handbook comprised of an electronically accessible collection of information documents having a organization structure, in an electronically accessible handbook repository;
(b) importing a current user handbook into a handbooks space associated with an identified individual on the first computer system;
(c) receiving instruction at the first computer system to modify the current user handbook in the handbooks space, the modification including changing at least one of an organization and an information document; and
(d) publishing the modified current user handbook into the electronically accessible handbook repository.

10. The method of claim 9, further including associating authorship information with the modified current user handbook, the authorship information including the identification of the current user and authorship information associated with the current user handbook.

11. The method of claim 10, where the information document includes handbooks and associated organization structure and author identification.

12. The method of claim 11, wherein the author identification for an information document or a handbook is assigned to any handbook including that electronic information content or handbook.

13. The method of claim 11, wherein the organization structure of an included handbook is preserved within an including handbook.

14. The method of claim 9, further including verifying authentication credentials of the author prior to publishing the modified current user handbook.

15. The method of claim 13, further including receiving a request to apply the organization content of an included handbook in the including handbook.

16. An electronic community computer system for sharing information implemented on at least one electronic computer executing a stored program to:
(a) register individual users with tags indicating interest;
(b) receive electronic documents from individuals for storage in a computer readable medium of the electronic community computer system;
(c) receive an electronic search request identifying at least one electronic document;
(d) display the identified at least one electronic document;
(e) receive at least one expertise points award designation for the identified at least one electronic document;
(f) determine whether cumulative expertise points award designation for at least one electronic document are greater than a threshold for at least one individual user having a tag indicating interest in that type of electronic document; and
(g) transmit the electronic document to the at least one individual user based on the determination.
